(19) United States
(12) Patent Application Publication
(10) Pub. No.: US 2018/0085965 A1
(43) Pub. Date: Mar. 29, 2018

(54) Safety Warning System for Detecting Non-Powered Freewheeling in High-Speed Cutting Machinery

(71) Applicants: Jeffrey A. Boerner, Bethlehem, PA (US); Brian D. Feldman, Macungie, PA (US)

(72) Inventors: Jeffrey A. Boerner, Bethlehem, PA (US); Brian D. Feldman, Macungie, PA (US)

(21) Appl. No.: 15/279,067

(22) Filed: Sep. 28, 2016

(51) Int. Cl. B26D 5/00

(52) U.S. Cl. CPC B26D 5/007; B26D 5/005

(57) ABSTRACT

A safety warning system that detects the continuation of motion or freewheeling of a cutting device after power has been switched off through measurement of the magnetic field surrounding the motor, or other moving component, and provides a predesignated scheme of warning lamp illumination to indicate the cutting device remains in motion and a hazardous condition exists.

### BACKGROUND OF THE INVENTION

The present invention is a safety device designed to detect whether cutting surfaces in electrically powered high speed machinery continue in motion after power to the motive device is switched off (freewheeling) or have come to rest and remain stationary by measuring the change in magnetic field surrounding the electric motor (or other changing magnetic field) by providing either a visual and/or audible warning indicating the motion or non-motion of the cutting surface of the machinery. More specifically, one of the proposed uses for the safety device is to detect when electrically powered equipment is in an operational state, but more importantly that the cutting surfaces are still moving, a freewheeling condition of the equipment, after the motive power has been switched off. The purpose of the safety device is to alert nearby people that the machine is not in a stopped condition regardless of whether the machine is being operated or not. Another proposed use of the safety device is to monitor and record equipment run and run duration times by detecting and measuring active motive power and the stopped condition of the electric motor.

There exist a large number of machines that power rotating components or cutting surfaces that build up sufficient inertia such that the cutting surfaces continue to move at a high rate of speed even after the motive force has been removed before coming to a complete rest. Only a small percentage of high speed equipment will include an indicator lamp signifying that the equipment is powered “on”, but this lamp usually indicates only that power is applied to the motor and cannot indicate whether the machinery continues in motion (freewheeling) after the motor has been turned off. In many instances, spinning or moving components, i.e., cutting surfaces, that are freewheeling present extreme safety hazards until these components come to a complete stop.

Approximately 40,000 people arrive at hospital emergency rooms every year with injuries sustained while operating high speed rotational equipment having a cutting blade, e.g., table saws. About 4,000 of those injuries—or more than 10 every day—result in amputations. Just this type of injury alone costs employers approximately $2 billion every year.

Current table saw standards have proven ineffective in protecting their operators. The primary technology used by the majority of table saw manufacturers to prevent table saw injuries is a plastic blade guard. This protective technology has remained essentially the same for over 50 years. Yet blade guards have proven to be ineffective in reducing the number of serious table saw injuries that occur every year.

The reason for the ineffectiveness lies with the operability of the table saw and the positioning of the blade guard. Guards must be removed in order to perform many tasks on a table saw, such as cutting a notch in a work piece. Users find the blade guards cumbersome to remove and replace and many simply remove the guards from the saws. Statistics from a reputable injury reporting service indicates that in approximately ⅔ of table saw injuries that guard was removed prior to the injury. Further, even with the guard still in place, almost ⅓ of table saw injuries still occur.

There are existing solutions that are designed to prevent serious injury if a person comes into contact with a cutting blade of a table saw. SawStop, a company located in Oregon, has developed a table saw system that will stop the blade within milliseconds of skin contact with a rotating blade. The blade carries a small electrical signal, which the safety system continually monitors. When skin contacts the blade, the signal varies from normal because the human body is conductive, with the detected change to the signal activating the safety system. The safety system includes an aluminum brake located below the table and adjacent to the rotating blade. Once skin contact is detected the safety system is activated and the aluminum brake springs forward into the teeth of the spinning blade, stopping the blade in less than 5 milliseconds. The resulting contact between the blade and brake drives the blade beneath the table due to angular momentum, removing the risk of subsequent contact with the blade. At the same instant of detection all power to the motor is shut off. This process of stopping the blade is destructive to the blade so that a new blade must be placed in the table saw and realigned for further use of the saw. Although this safety equipment is available currently, and it has demonstrated effectiveness, widespread acceptance is lacking in the industry. A different safety apparatus has been developed by a consortium of table saw manufacturers that will retract the blade below the table within milliseconds of contact to minimize injury. However, this safety device has not yet been brought to the market.

The benefits of improving table saw safety, along with other high speed cutting equipment, outweighs the costs of upgrading and far outweighs the costs of employee lost time and health care expense. It is estimated that the cost to place automatic safety devices on every table saw would be approximately $100 per saw. According to an early 2000's paper regarding table saw injuries from the U.S. Office of Information and Regulatory Affairs, an average table saw equipped with an automatic safety system will deliver $753 in benefits due to a reduction in injuries. This cost savings is many times greater than the cost to equip table saws with the automatic safety system. It is apparent that requiring such an automatic safety system would be cost-effective without including in the monetary savings the costs and benefits of eliminating the pain, suffering and emotional trauma that serious injuries impose on victims and families.

The table saw industry is resisting change by using many of the arguments put forward by vehicle manufacturers to delay airbag requirements for 20 years. During that time period an estimated 162,000 people died unnecessarily. In just the eight years that the Power Tool Industry has opposed automatic safety device inclusions on table saws, an estimated 320,000 serious table saw injuries have occurred, including 32,000 amputations. The argument put forward is that the requirement would be too costly. But cost-benefit analysis shows that 40,000 serious injuries would be prevented every year with the safety equipment installed.

Blade guards, or other cutting surface guards on other high speed cutting machinery, work if operators will utilize them. However, blade guards must be removed for many types of cuts made on a table saw so they cannot be used all of the time. Automatic safety devices on a table saw, in contrast, can be used regardless of the type of cut being made on whatever kind of work piece. Although people tend not to use blade guards because they are cumbersome and often interfere with the work, automatic safety devices, such as the present invention, do not require user intervention and do not interfere with the work.

It is, therefore, an object of the present invention to provide an indication to an operator that the cutting apparatus is still in motion and presents an immediate danger to the operator. It is another object of the present invention to provide a safety indication device that can be retrofitted onto existing high speed cutting equipment with little or no change to the machinery. It is still another object of the present invention to provide both a visual and an audible alarm to an operator if the cutting apparatus is freewheeling and still in motion.

In addition, it is yet another object to provide a safety device that will monitor high speed cutting machinery run times for purposes of safety, security, usage monitoring, maintenance detection, and equipment compliance standards. It is a further object of the present invention to also provide distance monitoring of the high speed cutting machinery to remotely monitor the machinery without the need for costly modifications to the machinery.

Other objects will appear hereinafter.

### SUMMARY OF THE INVENTION

The present invention is a safety device designed to specifically detect whether blades and/or cutting surfaces of high speed cutting equipment are in motion under power and remain in motion (freewheeling) after the motive power has been switched off until such cutting surfaces become stationary. An associated warning indicator, either visual or audible, or both, will indicate that the cutting surface continues in motion until coming to a complete stop.

A safety warning system for use with a high speed electrically powered cutting device to indicate an unsafe condition to an operator after power has been switched off is comprised of a power source for providing appropriate voltage levels to the safety warning system, a detector for indicating motion of the cutting blade or surface by monitoring change in a magnetic field surrounding an electric motor powering the cutting blade or surface and outputting a magnetic field value signal, a controller for monitoring and receiving the magnetic field value signal from the detector and responding by outputting an illumination output signal containing a predetermined illumination scheme appropriate to the state of the cutting blade or surface motion, and an illuminable alarm of one or more lamps for indicating the predetermined scheme appropriate to the state of the cutting blade or surface motion to be viewed by an operator. The detector for indicating motion of the cutting blade or surface is mounted in close proximity to the electric motor providing motive power to the high speed cutting device in order to detect changes in any magnetic field generated by the electric motor. In this fashion the safety warning system indicates to the operator either a hazardous or a safe condition of the high speed cutting device.

The safety warning system may also be positioned with the detector for indicating motion of the cutting blade or surface by monitoring change in the magnetic field remotely from the electric motor powering the cutting blade or surface proximate to a drive gear or wheel that operates in tandem with the electric motor such that the detector monitors the change in magnetic field of such drive gear or wheel. If the magnetic field appears to be weak, then one or more magnets can be mounted to the drive gear or wheel to augment the strength of the magnetic field for greater ease in monitoring change in the magnetic field by the detector.

The illuminable alarm of one or more lamps of the safety warning system is mounted to the high speed cutting device in full view of said operator as the operator may be preparing to use the high speed cutting device. The illumination alarm for indicating the predetermined scheme appropriate to the state of the cutting blade or surface motion having a predetermined illumination scheme may be any such illumination scheme selected from the group of illumination patterns consisting of constant single color illumination, varied intensity single or multi-colored illumination, sequentially changing single or multi-colored illumination based upon the state of the motion of the cutting blade or surface, varied intermittent single or multi-colored illumination, varied multi-colored illumination depending upon the value of the magnetic field value signal, and any combination of illumination patterns. The illuminable alarm for indicating the predetermined scheme appropriate to the state of the cutting blade or surface motion may also consist of any illumination patterns consistent with safety standards for illuminated warning lamps.

The safety warning system may be further comprised of an alarm circuit for controlling and indicating the predetermined scheme appropriate to the state of the cutting blade or surface motion to be viewed by the operator. The safety warning system can also be comprised of an audible alarm in combination with or in addition to the illuminable alarm for indicating the predetermined scheme appropriate to the state of the cutting blade or surface motion for indicating to the operator by audible sound an unsafe or hazardous condition. The audible alarm can be mounted proximate to the high speed cutting device order for said operator to hear as the operator may be preparing to use the high speed cutting device.

The safety warning system may also contain a communication module for transmitting the magnetic field value signal from the detector received by the controller over a designated communications pathway to an external computing device. The designated communications pathway for the communication module may be either by wireless or wired connectivity.

The safety warning system may also house a temporary data storage module for receiving and retaining the series of data contained in the magnetic field value signal from the controller indicative of change in the magnetic field surrounding the electric motor powering the cutting blade or surface. The temporary data storage module is capable of transmitting stored data indicative of the change in magnetic field value over a designated communications pathway to an external computing device.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a side view of a table saw with the safety warning detector of the present invention mounted to the saw motor below the table and the warning lights mounted to the table fence.

FIG. 2 is a block diagram of the several parts of the safety warning system of the present invention.

FIG. 3 is a block diagram of a second embodiment of the safety warning system of the present invention.

FIG. 4 is a front view of a band saw and housing with upper door open.

FIG. 5 is an isolated side view of the upper drive wheel of the band saw of FIG. 4 showing one or more magnets positioned on the rear side of the wheel with the safety warning device of the present invention mounted behind and in linear relation to the circular path of the one or more magnets mounted to the wheel.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

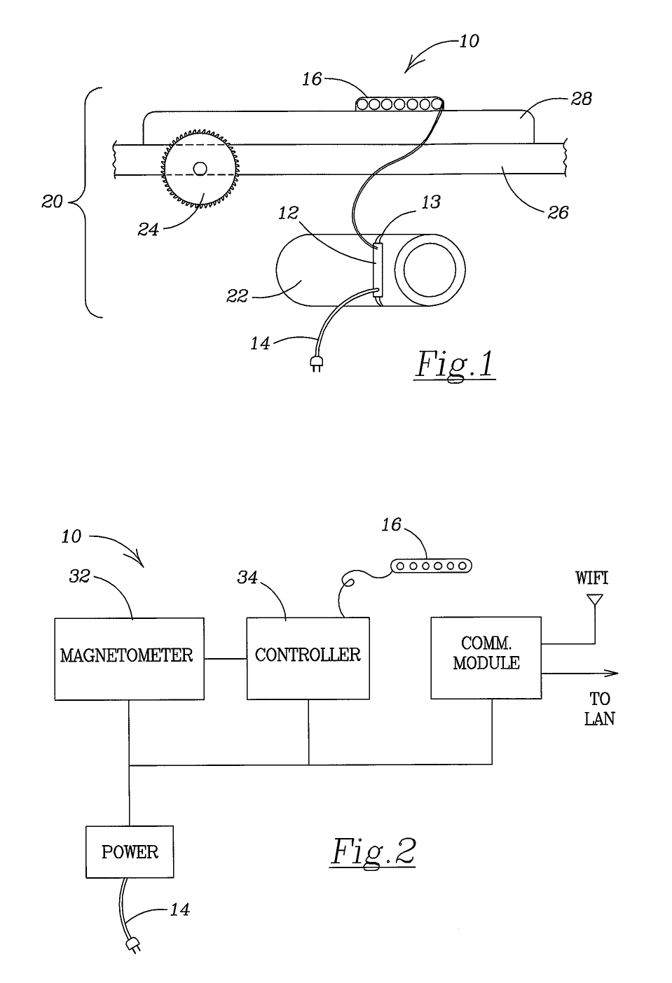

Referring now to the drawings in detail, where like numerals refer to like parts or elements, there is shown in FIG. 1 a representation of the safety warning system 10 of the present invention mounted about the electric motor 22 powering a table saw 20 having a circular saw blade 24. The circular saw 24 is mounted to a table 26 with its motive force electric motor 22 shown beneath the table 26. Mounted atop the table 26 next to the saw blade 24 is a fence 28 for guiding the work piece to be cut.

The safety warning system 10 is composed of a detector 12 mounted on, around or in immediate proximity to the motor 22. The detector 12 may be held in position by a strap or straps 13, as shown, or by any other means now known or later discovered that will retain the detector in the immediate proximity of or against the motor housing. The straps 13 hold the detector directly against the motor housing and prevent the detector 12 from moving around on the housing due to any vibration. The detector 12 may be powered by long-lived batteries, rechargeable batteries, or by standard AC voltage as shown by cord and plug 14. Also connected to the detector is an illuminable warning lamp or lamps 16 for providing a visual warning to the table saw operator. The warning lamps 16 can be a single LED, or a series of LEDs, that can be mounted to the operable equipment in any position within the normal field of view of an operator such that operator will see the lamps prior to engaging in any operation of the table saw 20. In the example shown in FIG. 1, the warning lamps 16 are mounted atop the fence 28.

Referring now to FIG. 2, there is shown an operational block diagram depicting the present invention, the safety warning system 10. Starting with the power to the safety warning system 10, power may be obtained from an existing electrical system within the structure housing the high-speed cutting machinery through cord and plug 14. The electrical voltage will likely be 120 or 240 volts AC and will need to be transformed and reduced to a voltage required to power the on-board elements of the safety warning system 10 such that the voltages converted to DC and reduced to a range of between 5 and 20 volts DC. This can be accomplished by any known device providing step-down transformation and rectification of the AC power to a power level required for the internal devices to operate all within the block marked POWER. Alternatively, power can be derived from one or more on-board batteries that will individually or collectively provide the voltage required to power and drive the other on-board elements of the safety warning system 10. The battery voltage will range from +5 VDC to approximately +20 VDC depending upon the specific power distribution provided by the safety warning system 10 within the block marked POWER. Further, the batteries can be long-lived batteries or rechargeable batteries depending upon the requirements for continuing use of the safety warning system 10. The on-board POWER devices, or the external power source (used directly or as a charging source for the on-board batteries), provide the required voltage for operating the various other on-board devices of the safety warning system 10, the magnetometer 32, the controller 34 and associated elements that are connected to the controller 34.

The first of the operational devices is the magnetometer 32 that is to be positioned in close proximity to the high-speed cutting machine's motor 22. This is of utmost importance as the magnetometer 32 will be utilized to detect changes in the electromagnetic field surrounding the motor 22, but from outside the motor casing or housing. The magnetometer that is being used may be classified as a relative magnetometer that is capable of measuring a magnitude or vector magnetic field relative to a fixed but uncalibrated baseline. This type of magnetometer may also be referred to as a variometer. Relative magnetometers can be used to measure variations in a magnetic field as is done in the case of the present safety warning system 10.

In order to provide the closeness or proximity relationship between the magnetometer 32 and the rotor/stator combination of the motor 22 that creates the magnetic field, the preferred positioning of the magnetometer 32 is to strap the safety warning system 10 directly to the motor casing at a position overlying the rotor/stator combination in order to lie within the external magnetic field generated by the movement of the rotor. The magnetometer 32 will respond to any fluctuation in the magnetic field generated by the motor 22 including the freewheeling of the motor 22 after power is removed and the lack of any generated field when the motor 22 finally stops.

The Controller 34 manages the detection function of the safety warning system 10 by repeatedly sampling the sensed value of the changing magnetic field of the motor 22 as detected by the magnetometer 32. If the detected sensed value of the magnetic field is changing and not static, then the safety warning lamps 16 will be illuminated indicating that the motor 22 is under power or freewheeling and the saw blade 24 is in motion. The Controller 34 is connected to the warning lamps 16 by a cable, but may also be wirelessly connected so that the placement of the warning lamps 16 can be anywhere in proximity to the cutting device, e.g., the circular saw blade 24, without restriction of being limited by the connecting cable.

The Controller 34 is a specialized microprocessor programmed to repeatedly sample the output value of the magnetometer 32 and compare that value over time. Any detected or sampled value other than a static value will be an indication that the cutting device 24 is still in motion as that device is directly linked to the motor 22 which is not stopped as indicated by the existence of a magnetic field surrounding the motor casing. If a value other than a static value is detected by the Controller 34, then the warning lamps 16 will be illuminated indicating to the operator that the cutting device 24 is still in motion. The Controller 34 can be programmed to provide a sequence of illumination changes, such as fast or slow blinking of the warning lamps 16, or an interspersed constant illumination between a series of blinks, or a sequential blinking of the lamps starting at one end, or a random sequence of blinking lamps, so that the attention of the operator is drawn to the warning lamps 16 and the indication that the cutting device 24 remains in motion and to beware of that dangerous condition. The warning lamps 16 can also be multi-colored LED lamps so that the sequence of illuminations can vary color to attract the attention of the operator or to indicate the speed of the cutting device 24 as it slows down by changing from Red to Yellow to Green as the cutting device 24 comes to a stop.

Monitoring of the individual safety warning systems 10 can be accomplished through the Communication Module 36 that receives a signal from the Controller 34 that the safety warning system 10 is operational and then, if the cutting device 24 is in motion, that the cutting device 24 is powered or is freewheeling and not stopped. This signal can be transmitted through an appropriately configured Wi-Fi connection or by a specialized Wi-Fi connection such as Bluetooth®. Alternatively, the safety warning system can communication through a limited area network or LAN to a local computer (not shown) that is appropriately configured to monitor individual or multiple safety warning systems 10.

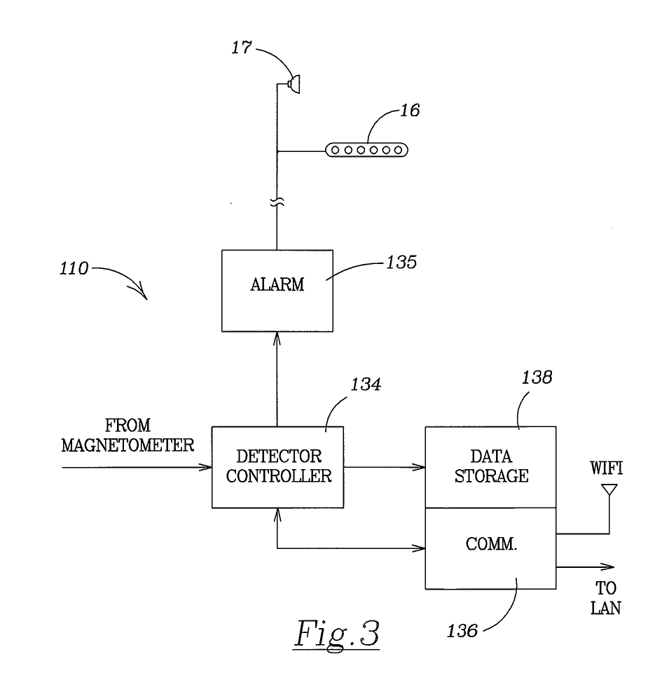

Referring now to FIG. 3, a safety warning system 110 having a number of separate components is shown. The safety warning system 110 receives a sampled value from the magnetometer in the detector controller 134 which controls the sampling timing and processes the signal to determine whether the value received is still changing or attains a static value. If the sensed value is changing, then a signal is sent to the alarm circuit in Alarm 135 that can be programmed to create any illumination scheme desired for the warning lamps 16 as described above. The purpose of the warning lamps 16 is to attract the attention of the operator and to indicate that the cutting device 24 remains in motion even when power has been removed from the motor 22. To do this the alarm circuit of Alarm 135 is alternately or sequentially programmable to provide sequencing of the lamps, color changes of the lamps, and blinking or continuous illumination of the lamps in any desired patterning.

In this embodiment of the safety warning system, the addition of a Data Storage Module 138 provides for on-board temporary storage of an event log and safety warning systems conditions during operation of the high speed cutting machinery 20. The Controller 134 can be programmed to send detected values of the magnetometer 32 to the Data Storage Module 138 as soon as a value other than static or unchanging is detected by the magnetometer indicating that the motor 22 is operational and producing a magnetic field and that the cutting device 24 is in motion producing a hazardous condition. The event log can be updated with the start of the high speed cutting machine 20 and again when the magnetic field becomes non-existent and the cutting device 24 has come to a complete stop. The collected data is temporarily stored in the Data Storage Module 138 until a designated time to communicate the stored data to a locally or distantly connected computer for collection and retention.

The temporarily stored data is communicated over one of two pathways, the LAN or by the Wi-Fi connection. The transmission of the data is controlled by the Communication Module 136 such that the temporarily stored data is transferred to the connected computing device (not shown) to be analyzed and retained. The temporarily stored data is retained in the Data Storage Module 138 of the safety warning device 110 even after power is removed and until the Data Storage Module 138 reaches its capacity. When capacity is reached, the Data Storage Module 138 requests the transfer of data, and if the data is not transferred some of the data will be overwritten.

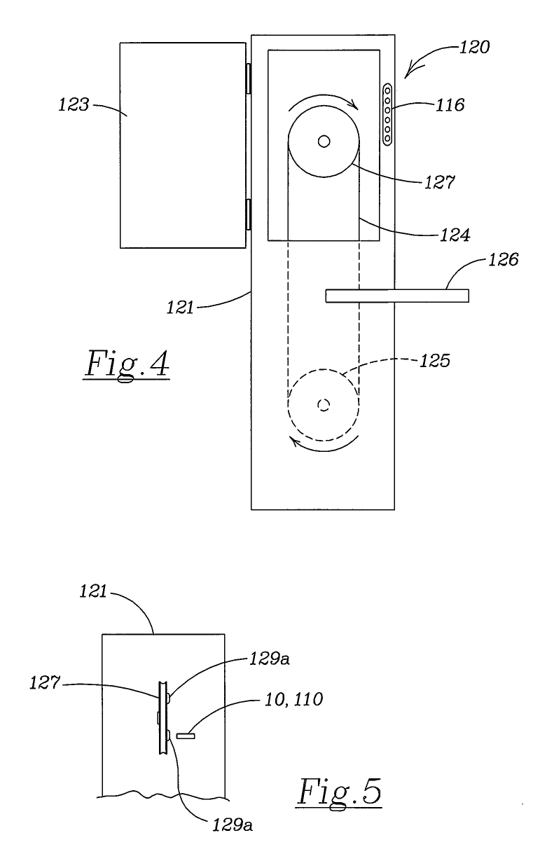

Other electrically powered cutting devices such as band saws, lathes, table planers and routers, as well as disk sanders and other abrasive electrically powered devices, are also considered to be included as high speed electrically powered cutting devices that can be monitored for freewheeling as part of the present invention. In FIGS. 4 and 5, a band saw 120 is shown mounted in a cabinet 121 with the upper door 123 of the cabinet in the open position. Although the safety warning system 10, 110 of the present invention could be mounted to the motor housing behind the lower drive wheel 125 driving the cutting surface, the band saw 124, as in the table saw application, we will focus on an alternative mounting on the upper drive wheel 127. The band saw 124 travels over the upper drive wheel 127 and returns to the lower drive wheel 125 passing through the cutting table 126. Referring to FIG. 5 in particular, mounted to the rear facing surface of the upper drive wheel 127 are two magnets 129a, 129b, that rotate in tandem with the drive wheel 127. Spaced apart and in linear relationship with the circular path of the two magnets 129a, 129b is the safety warning device 10, 110 of the present invention. The magnets 129a, 129b travelling in a circular path with the drive wheel 127 cause a continually changing magnetic field that will be detected by the magnetometer 32 of the safety warning device 10, 110 for so long as the drive wheel is powered and until the non-powered freewheeling ceases. The example provides a pair of magnets 129a, 129b, but other arrangements of either a single magnet or arrays of multiple magnets will also work. It is also quite possible that the rotating drive wheel, if made of a sufficient iron content, will also create a fluctuating magnetic field that can be measured. In all other respects, the safety warning device 10, 110 operates in the same efficient manner as described above in regard to the other associated elements.

The safety warning systems 10, 110 will remain operational so long as it is powered by line voltage or battery power. The warning lamps 16 are configurable to sequence illumination of all lamps or individual lamps to attract the attention of the operator for as long as the high speed cutting machinery 20 is operational. When the power is removed from the high speed cutting machinery 20 and the motor 22 is freewheeling the lamp sequence and/or color of the warning lamps can be changed to indicate a change in the status of the cutting device 24 from powered to freewheeling, while still indicating a hazardous condition. This could entail a change from constant illumination while the cutting device 24 and motor 22 are under power to an intermittent illumination scheme and/or color change when the motor 22 and cutting device 24 are freewheeling. The warning lamps 16 could also change to a green illumination when the machinery is in a safe condition indicating the freewheeling has ceased and the cutting device 24 has stopped. Illumination patterns consistent with safety standards for illumination are also to be considered part of the present invention.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A safety warning system for use with a high speed electrically powered cutting device to indicate an unsafe condition to an operator after power has been switched off comprising:
a power source for providing appropriate voltage levels to the safety warning system;
a detector for indicating motion of the cutting blade or surface by monitoring change in a magnetic field surrounding an electric motor powering the cutting blade or surface and outputting a magnetic field value signal;
a controller for monitoring and receiving the magnetic field value signal from the detector and responding by outputting an illumination output signal containing a predetermined illumination scheme appropriate to the state of the cutting blade or surface motion; and
an illuminable alarm of one or more lamps for indicating the predetermined scheme appropriate to the state of the cutting blade or surface motion to be viewed by an operator, wherein said safety warning system indicates to said operator either a hazardous or a safe condition of the high speed cutting device.

2. The safety warning system of claim 1, wherein said illuminable alarm of one or more lamps is mounted to the high speed cutting device in full view of said operator as the operator may be preparing to use the high speed cutting device.

3. The safety warning system of claim 1, further comprising a communication module for transmitting the magnetic field value signal from the detector received by the controller over a designated communications pathway to an external computing device.

4. The safety warning system of claim 4, wherein the designated communications pathway of the communication module may be either by wireless or wired connectivity.

5. The safety warning system of claim 1, wherein the detector for indicating motion of the cutting blade or surface is mounted in close proximity to the electric motor providing motive power to the high speed cutting device in order to detect changes in any magnetic field generated by the electric motor.

6. The safety warning system of claim 1, wherein the illumination output signal for indicating the predetermined scheme appropriate to the state of the cutting blade or surface motion may be one selected from the group of illumination patterns consisting of constant single color illumination, varied intensity single or multi-colored illumination, sequentially changing single or multi-colored illumination based upon the state of the motion of the cutting blade or surface, varied intermittent single or multi-colored illumination, varied multi-colored illumination depending upon the value of the magnetic field value signal, and any combination of illumination patterns.

7. The safety warning system of claim 1, further comprising an alarm circuit for controlling and indicating the predetermined scheme appropriate to the state of the cutting blade or surface motion to be viewed by the operator.

8. The safety warning system of claim 1, further comprising a temporary data storage module for receiving and retaining the series of data contained in the magnetic field value signal from the controller indicative of change in the magnetic field surrounding the electric motor powering the cutting blade or surface.

9. The safety warning system of claim 8, wherein the temporary data storage module being capable of transmitting stored data indicative of the change in magnetic field value over a designated communications pathway to an external computing device.

10. The safety warning system of claim 1, wherein the illuminable output signal for indicating the predetermined scheme appropriate to the state of the cutting blade or surface motion may consist of illumination patterns consistent with safety standards for illuminated warning lamps.

11. The safety warning system of claim 1, further comprising an audible alarm in combination with or in addition to the illuminable alarm for indicating the predetermined scheme appropriate to the state of the cutting blade or surface motion for indicating to the operator by audible sound an unsafe or hazardous condition.

12. The safety warning system of claim 11, wherein the audible alarm is mounted proximate to the high speed cutting device order for said operator to hear as the operator may be preparing to use the high speed cutting device.

13. The safety warning system of claim 1, wherein the detector for indicating motion of the cutting blade or surface by monitoring change in a magnetic field is positioned remotely from the electric motor powering the cutting blade or surface proximate a drive gear or wheel that operates in tandem with the electric motor with such detector monitors the change in magnetic field of such drive gear or wheel.

14. The safety warning system of claim 13, wherein one or more magnets are mounted to the drive gear or wheel to augment the strength of the magnetic field for greater ease in monitoring change in the magnetic field by the detector.
